(19) United States
(12) Patent Application Publication
(10) Pub. No.: US 2010/0288585 A1
(43) Pub. Date: Nov. 18, 2010

(54) FOLDING SAWHORSE

(75) Inventors: Amir Katz, Bat-Heffer (IL); Eitan Landau, Ramat-Gan (IL)

Correspondence Address: PILLSBURY WINTHROP SHAW PITTMAN, LLP, P.O. BOX 10500, MCLEAN, VA, 22102, US

(73) Assignee: ZAG Industries, Ltd., Rosh Ha'Ayin (IL)

(21) Appl. No.: 12/467,147

(22) Filed: May 15, 2009

(51) Int. Cl. B27B 21/00

(52) U.S. Cl. 182/155

(57) ABSTRACT

A folding sawhorse includes an elongate plastic body having a top wall with an upper work surface, and a plurality of side walls, the walls defining a storage compartment. The folding sawhorse further comprises a plurality of metal legs that are pivotally disposed relative to the plastic body, the legs being movable between a deployed position wherein the legs are capable of supporting the plastic body in a condition for use, and a storage position in which the legs are folded so as to be substantially disposed in the storage compartment, wherein the metal legs forcibly engage with adjacent plastic surfaces of the plastic body when the legs are deployed. The folding sawhorse further comprises each leg pair comprising a first pivot axis allowing the pair of legs to be pivoted together outwardly from the storage compartment to an extended position, and a second pivot axis allowing pair of legs to be pivotally separated away from one another to the deployed position. The folding sawhorse may further comprise a handle portion recessed in the top wall so as not to project above the work surface. The folding sawhorse may further comprise a latch member pivotally connected with one of the side walls and latchable to an opposite of the side walls to lock the legs in the storage compartment

### FIELD OF THE INVENTION

The present invention relates to a folding sawhorse.

### BACKGROUND OF THE INVENTION

Conventional sawhorses commonly are comprised of a body and legs that support the body. The body is used to support workpieces that are to be cut or otherwise worked on. There is a need in the art for an improved sawhorse.

### SUMMARY OF THE INVENTION

A folding sawhorse is disclosed. The folding sawhorse comprises an elongate plastic body having a top wall with an upper work surface, and a plurality of side walls, the walls defining a storage compartment. The folding sawhorse further comprises a plurality of metal legs that are pivotally disposed relative to the plastic body, the legs being movable between a deployed position wherein the legs are capable of supporting the plastic body in a condition for use, and a storage position in which the legs are folded so as to be substantially disposed in the storage compartment, wherein the metal legs forcibly engage with adjacent plastic surfaces of the plastic body when the legs are in the deployed position.

In another aspect, the folding sawhorse comprises an elongate body having a top wall with an upper work surface, and a plurality of side walls, the walls defining a storage compartment. The folding sawhorse further comprises a plurality of legs, including a first leg pair pivotally mounted towards a first side of the body, and a second leg pair pivotally mounted towards a second side of the body. The folding sawhorse further comprises the legs being movable between a deployed position wherein the legs are capable of supporting the plastic body in a condition for use, and a storage position in which the legs are folded so as to be substantially disposed in the storage compartment. The folding sawhorse further comprises each leg pair comprising a first pivot axis allowing the pair of legs to be pivoted together outwardly from the storage compartment to an extended position, and a second pivot axis along the pair of legs to be pivotally separated away from one another to the deployed position.

In another aspect of the invention, the folding sawhorse comprises an elongate, one-piece integrally molded plastic body, the one-piece integrally molded plastic body being molded to include each of (a) a top wall defining a work surface, (b) side walls, and (c) a handle portion recessed in the top wall so as not to project above the work surface. The folding sawhorse further comprises a plurality of legs that are connected with the body and capable of supporting the body in a condition of use.

In another aspect, the folding sawhorse comprises an elongate body having a top wall with an upper work surface, and a plurality of side walls, the walls defining a storage compartment. The folding sawhorse further comprises a plurality of legs that are pivotally disposed relative to the body, the legs being movable between a deployed position wherein the legs are capable of supporting the plastic body in a condition of use, and a storage position in which the legs are folded so as to be substantially disposed in the storage compartment. The folding sawhorse further comprises a latch member pivotally connected with one of the side walls and latchable to an opposite of the side walls to lock the legs in the storage compartment.

These and other aspects of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein may be considered to be drawn to scale. It is to be expressly understood, however, that the drawings are for the purpose of illustration and description only and are not a limitation of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

FIG. 1 is a perspective view of a folding sawhorse in accordance with an embodiment of the present invention in a deployed position.

FIG. 2 is a perspective view of the folding sawhorse in a deployed position with the folding elements in an upright position.

FIG. 3 is a perspective view of the folding sawhorse with the legs partially collapsed toward each other.

FIG. 4 is a perspective view of the folding sawhorse with the legs fully collapsed together.

FIG. 5 is a perspective view of the folding sawhorse with the legs collapsed and partially folded inwardly.

FIG. 6 is a perspective view of the folding sawhorse with the legs further folded toward the storage compartment.

FIG. 7 is a perspective view of the folding sawhorse with the legs substantially disposed in the storage compartment.

FIG. 8 is a perspective view of a pivot structure.

FIG. 9 is a partial perspective view of the pivot structure forming a pivot axis for a pair of legs.

FIG. 10 is a perspective view of the pivot structure forming a pivot axis for a pair of legs.

FIG. 11 is a partial perspective view of the leg retaining compartment with a leg pair in a partially extended position.

FIG. 12 is a partial perspective view of the leg retaining compartment with the leg pair in a further partially extended position.

FIG. 13 is a partial perspective view of the leg retaining compartment with the leg pair in an extended position.

FIG. 14 is a partial perspective view of the leg retaining compartment with the leg pair in an extended position and partially separated.

FIG. 15 is a perspective view of the of the leg retaining compartment with the leg pair in an extended position and partially separated.

FIG. 16 is a partial perspective view of the leg retaining compartment with the leg pair in an extended position and pivotally separated to a deployed position.

FIG. 17 is a perspective view of the leg pair in a partially separated position.

FIG. 18 is a perspective view of the leg pair in a pivotally separated position.

FIG. 19 is a partial perspective view of the support rail showing the ring portions.

FIG. 20 is a perspective view of the leg pair with the ring portions of the support rail pivoted away from the plastic body.

FIG. 21 is a perspective view of the support rail, showing both ring portions and rod portions.

FIG. 22 is a perspective view of the support rail and rod receiving members.

FIG. 23 is a perspective view of the folding sawhorse with the legs in a storage position showing the latch member.

FIG. 24 is a partial perspective view of the folding sawhorse with a connecting latch held in a position along the side wall.

FIG. 25 is a partial perspective view of the folding sawhorse with the connecting latch pivoted away from the side wall.

FIG. 26 is a partial perspective view of the folding sawhorse with the connecting latch further pivoted away from the side wall.

FIG. 27 is a perspective view of the folding sawhorse showing the connecting latch.

FIG. 28 is a perspective view of the folding sawhorse showing the latch receiving abutments.

FIG. 29 is a perspective view of one folding sawhorse above another folding sawhorse.

FIG. 30 is a perspective view of one folding sawhorse aligned on top of another folding sawhorse.

FIG. 31 is a perspective view of two folding sawhorses latched together, forming a twin pack configuration.

FIG. 32 is a perspective view of a user carrying two sawhorses in a twin pack configuration with a carrying strap.

### DETAILED DESCRIPTION OF THE INVENTION

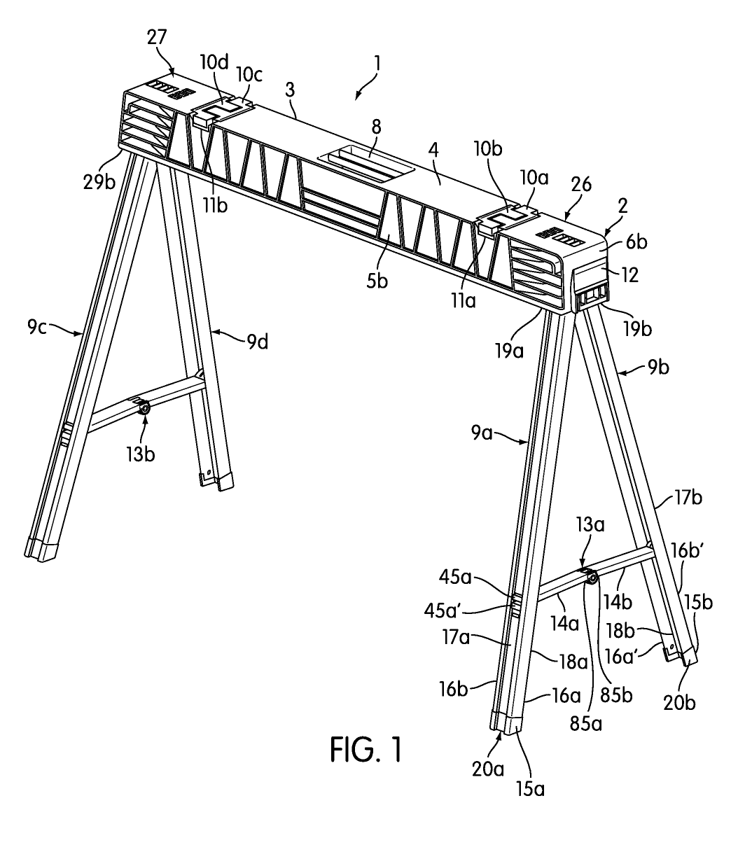

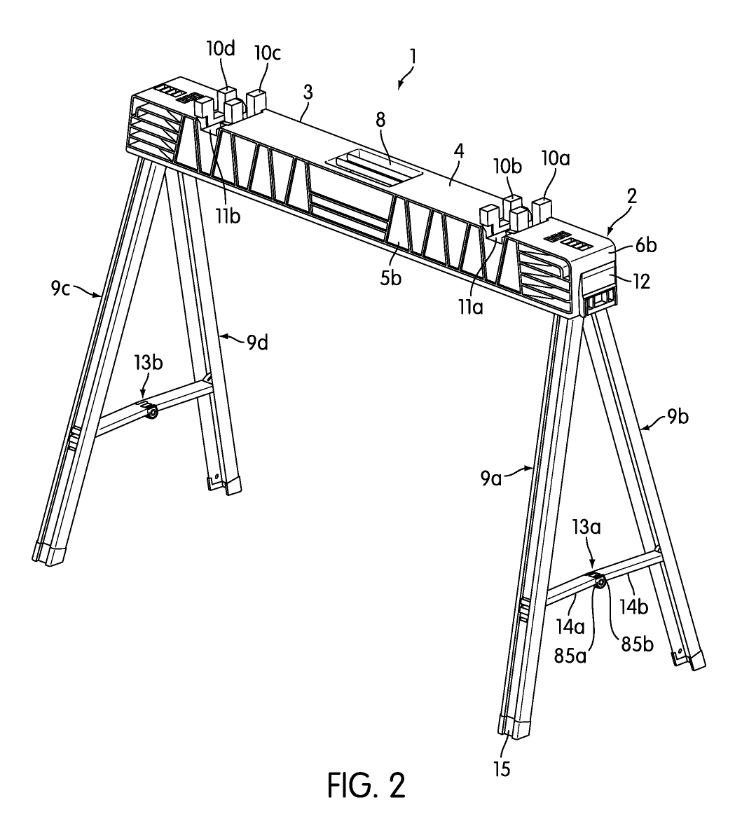

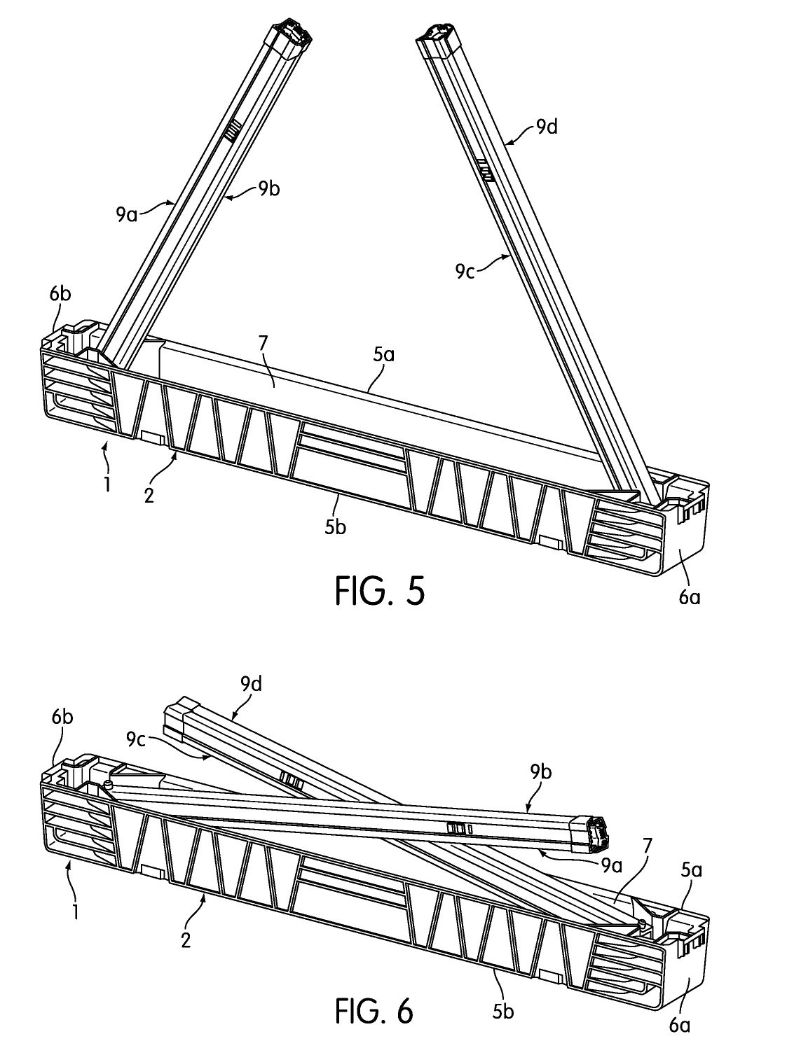

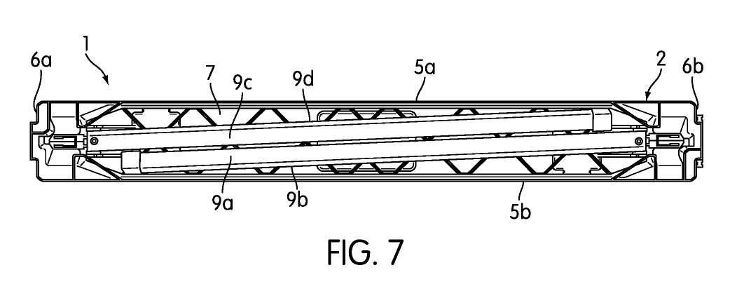

FIGS. 1 and 2 show a folding sawhorse 1 in accordance with an embodiment of the present invention in a deployed position. The folding sawhorse 1 includes an elongate plastic body 2 having a top wall 3 with an upper work surface 4, and a plurality of side walls 5a (shown in FIGS. 5, 6, and 7), 5b, 6a (shown in FIGS. 5, 6, and 7), and 6b, the walls defining a storage compartment 7 (as shown in FIGS. 5, 6, and 7). The folding sawhorse 1 further includes a plurality of metal legs 9a, 9b, 9c, and 9d that are pivotally disposed relative to the plastic body 2. The legs 9a, 9b, 9c, and 9d are movable between a deployed position wherein the legs 9a, 9b, 9c, and 9d are capable of supporting the plastic body 2 in a condition for use, and a storage position (as shown in FIG. 7) in which the legs 9a, 9b, 9c, and 9d are folded so as to be substantially disposed in the storage compartment 7. The metal legs can be made of any suitable metal such as steel or aluminum, for example.

In the embodiment shown in FIGS. 1 and 2, the top wall 3 is molded to include an integral plastic handle 8 recessed in the top wall 3 so as not to project above the work surface 4. The handle is integrally molded with the top wall 3 and side walls 5a, 5b, 6a, and 6b so that these are all a one-piece unitary molded structure. In one embodiment, the integral plastic handle 8 is molded into the top wall 3 of the elongate plastic body 2 along upper work surface 4 at a position that is substantially centered between the side walls 6a and 6b and between side walls 5a and 5b. The integral plastic handle 8 allows folding sawhorse 1 to be easily carried by hand. In another embodiment, a top surface of the handle 8 lies in the same plane as the top surface of the top wall 3, which serves as the major work surface. Thus, in one embodiment, the top surface of handle 8 can function as part of the work surface.

In the embodiment shown in FIGS. 1 and 2, the top wall 3 of the elongate plastic body 2 has folding elements 10a and 10b disposed in recess 11a, and 10c and 10d disposed in recess 11b. The folding elements are pivotally disposed relative to the top wall 3. The folding elements 10a, 10b, 10c, and 10d can be pivoted between a storage position in which the folding elements 10a, 10b, 10c, and 10d are folded so as to be substantially disposed within recesses 11a and 11b (as shown in FIG. 1), and an upright position (as shown in FIG. 2). In one embodiment, folding elements 10a, 10b, 10c, and 10d are of essentially identical construction. Because folding elements 10a, 10b, 10c, and 10d are essentially identical, only folding element 10a will be discussed in detail, but the discussion applies equally to folding elements 10b, 10c, and 10d. The folding element 10a has a through-hole (not shown) that transverses the length of the folding element along the lower end of folding element 10a. Furthermore, folding element apertures (not shown) are molded in the top wall 3 within the recess 11a. A metal rod (not shown) is then inserted into folding element aperture, through through-hole, and into another folding element aperture. This configuration allows folding element 10a to be pivotally disposed relative to the top wall 3.

In the embodiment illustrated in FIG. 1, legs 9a and 9b form a first leg pair that is pivotally disposed relative to each other, while legs 9c and 9d form a second leg pair pivotally disposed relative to each other. The first leg pair 9a and 9b is pivotally mounted towards a first side 26 of the plastic body 2. The first side 26 of the plastic body 2 is the side of the plastic body between the center of the plastic body and the outer surface by side wall 6b. The second leg pair 9a and 9b is pivotally mounted towards a second side 27 of the plastic body 2. The second side 27 of the plastic body 2 is the side of the plastic body between the center of the plastic body and the outer surface by side wall 6a. Because leg pair 9a and 9b and leg pair 9c and 9d are essentially identical, any discussion of leg pair 9a and 9b applies equally to leg pair 9c and 9d.

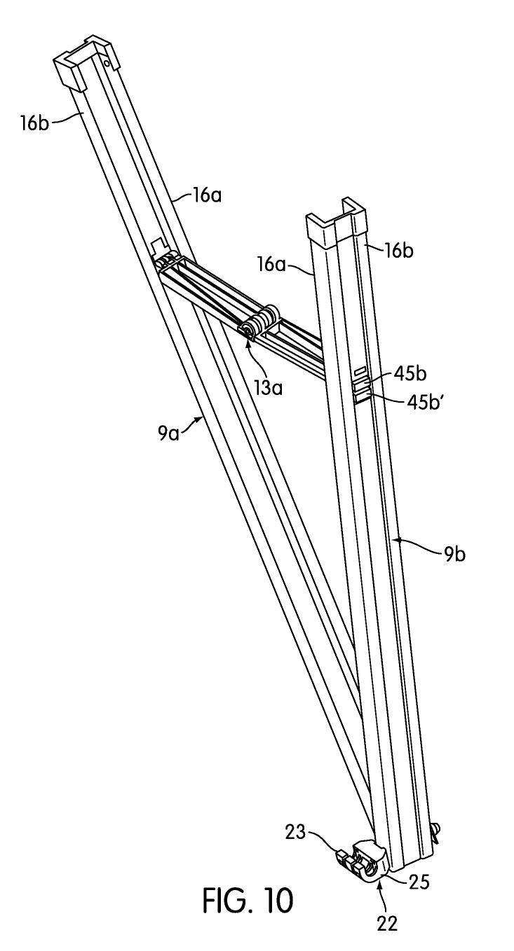

In the embodiment illustrated in FIG. 1, the leg 9a has a U-shaped cross section formed by two side rails 16a and 16b and a center rail 17a defining a channel 18a (obstructed from view by leg 9a) along the length of leg 9a. Similarly, leg 9b includes two side rails 16a′ and 16b′ and a center rail 17b (partially obstructed from view by side rail 16b′) defining a channel 18b along the length of leg 9b. The center rails 17a and 17b include openings 45a, 45a′ and 45b (shown in FIG. 10), 45b′ (shown in FIG. 10), respectively. The leg 9a and 9b each have two ends, top ends 19a (obstructed from view by plastic body 2), 19b (obstructed from view by plastic body 2), respectively, and bottom ends 20a, 20b, respectively. Furthermore, shoes 15a, 15b partially cover legs 9a, 9b, respectively, at the bottom ends 20a, 20b, respectively. The shoes 15a, 15b provide a slip resistant surface (e.g., made of plastic, rubber or elastomer) for the legs 9a, 9b when legs 9a, 9b are in a deployed position supporting the plastic body 2 in a condition for use. As legs 9c, 9d are substantially the same as legs 9a, 9b the foregoing description applies equally to those legs as well. The shoes 15a, 15b may also protect the underlying floor surface.

In the embodiment shown in FIGS. 1 and 2, an support rail 13a is disposed between leg pair 9a and 9b to further stabilize leg pair 9a and 9b in the deployed position. Support rails 13a and 13b are of essentially identical construction. Because support rail 13a and 13b are essentially identical, only support rail 13a will be discussed in detail, but the discussion applies equally to support rail 13b. The support rail 13a has two portions 14a and 14b. Each portion 14a and 14b is substantially one half of support rail 13a. The portions 14a and 14b are pivotally disposed relative to each other at ends 85a, 85b, respectively, and pivotally disposed relative to legs 9a and 9b via hinges disposed at openings 45a, 45a′ and 45b, 45b′ in the legs 9a and 9b (shown in FIG. 10), respectively. When the support rail 13a is in a straight position (shown in FIGS. 1 and 2) the leg pair 9a and 9b is in a deployed position, capable of supporting the plastic body 2 in a condition for use.

In the embodiment shown in FIGS. 1 and 2, the support rail 13a is made of plastic. The use of plastic is not intended to be limiting, and the support rail 13a may be made of any other suitable material or combination thereof as is well known in the art.

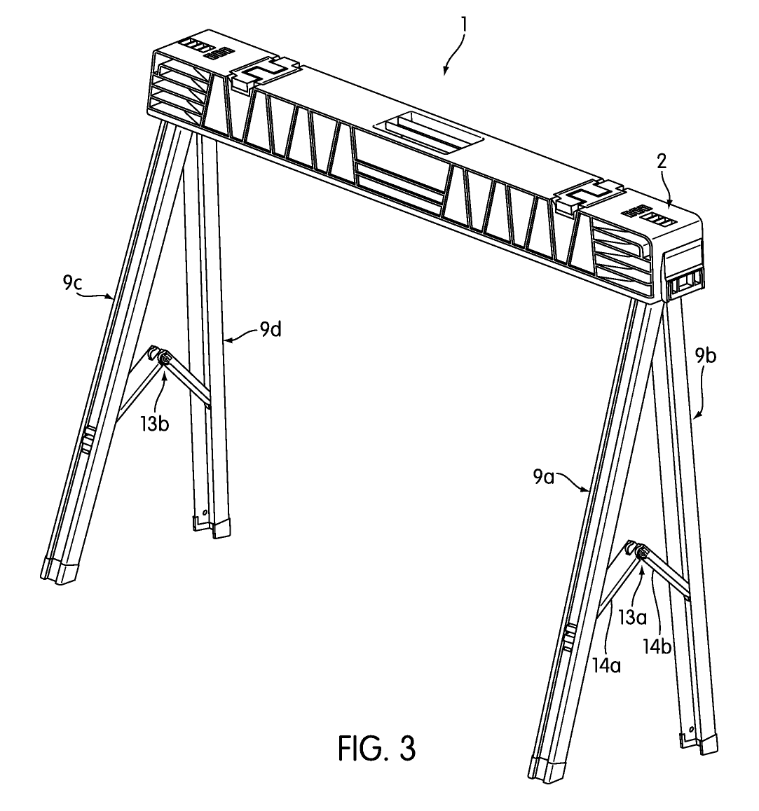

FIG. 3 shows an embodiment wherein legs 9a and 9b are partially collapsed inwardly toward each other. The support rail 13a is folded when portions 14a and 14b are collapsed toward each other.

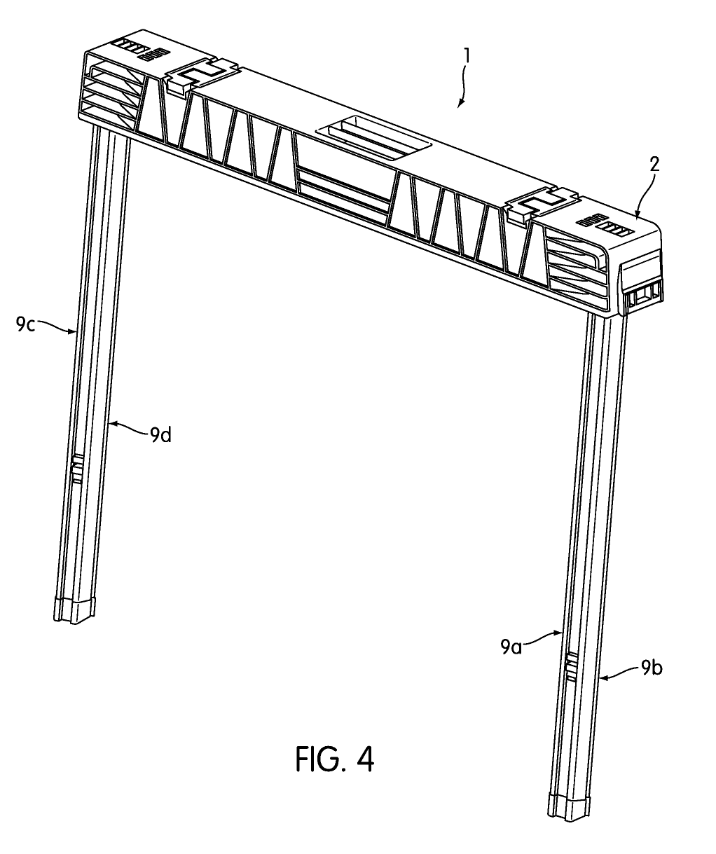

FIG. 4 shows an embodiment wherein leg pair 9a and 9b and leg pair 9c and 9d are fully collapsed together. Leg pair 9a and 9b and leg pair 9c and 9d are in an extended position. The support rail 13a is folded so that the two portions 14a (shown in FIG. 3) and 14b (shown in FIG. 3) are collapsed together. The support rail 13a is entirely disposed within channels 18a, 18b.

FIG. 5 shows an embodiment wherein the leg pair 9a, 9b and the leg pair 9c, 9d are fully collapsed together. Each leg pair 9a and 9b, and 9c and 9d is partially folded inwardly from the extended position toward the storage compartment 7.

FIG. 6 shows an embodiment wherein the leg pair 9a and 9b and the leg pair 9c and 9d are fully collapsed together. Each leg pair 9a and 9b, and 9c and 9d is further folded toward the storage compartment 7.

In the embodiment shown in FIG. 7, leg pair 9a, 9b and leg pair 9c, 9d are in a storage position in which the leg pair 9a, 9b and leg pair 9c, 9d are folded so as to be substantially disposed in the storage compartment 7.

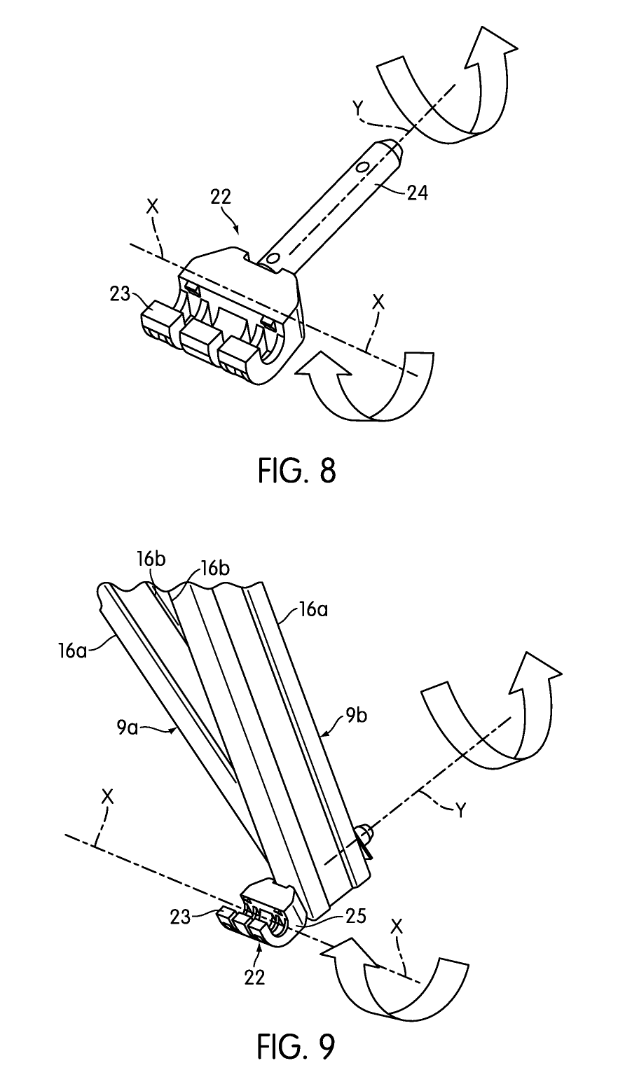

In the embodiment shown in FIG. 8, a pivot structure 22, which is used to pivotally mount a pair of legs to the body as will be described, comprises a recess portion 23 and a rod portion 24. The recess portion 23 forms a first pivot axis X. The rod portion 24 forms a second pivot axis Y. In the embodiment, the pivot structure 22 is made of plastic.

FIGS. 9 and 10 show an embodiment wherein the rod portion 24 of the pivot structure 22 is inserted through through-holes 25 (obstructed from view by pivot structure 22) formed in both side rails 16a, 16b and 16a′, 16b′ of the legs 9a and 9b, respectively. Therefore, the rod portion 24 of the pivot structure 22 forms the second pivot axis Y allowing the pair of legs 9a and 9b to be pivotally separated away from one another to and from the deployed position.

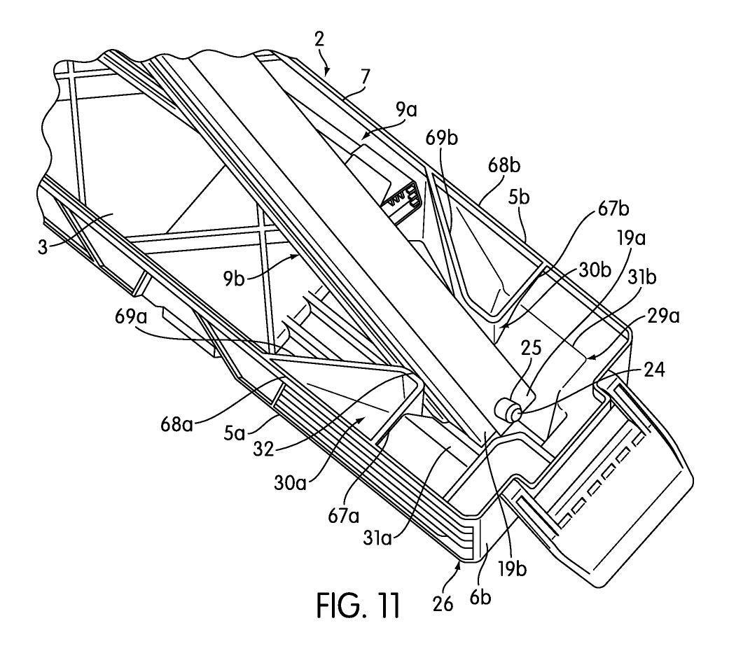

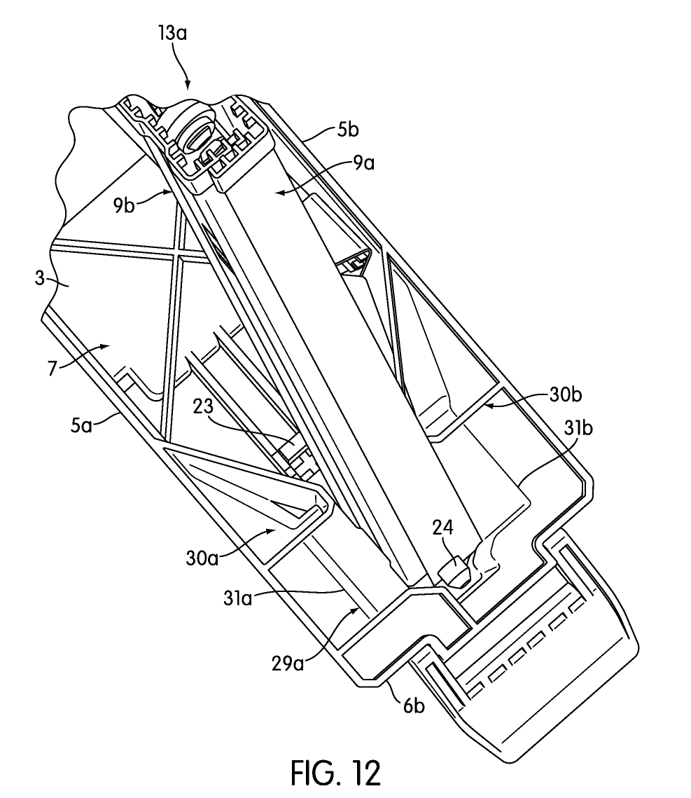

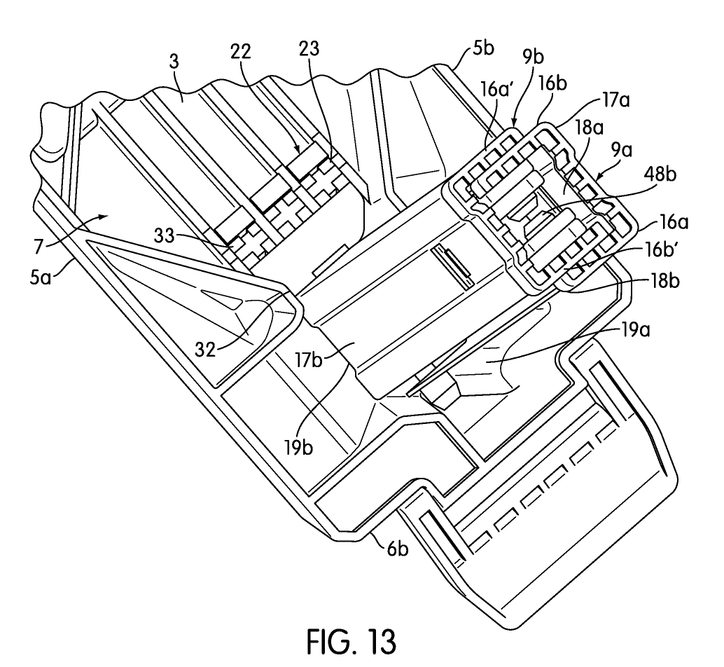

In the embodiment shown in FIG. 11, the leg pair 9a and 9b is pivoted relative to the first pivot axis X from the storage compartment 7 to a partially extended position. The rod portion 24 of the pivot structure 22 is inserted through through-holes 25 (partially obstructed from view by rod portion 24) formed in side rails 16a, 16b and 16a′, 16b′ of legs 9a, 9b, respectively. The recess portion 23 of the pivot structure 22 comprises a resilient C-shaped clamp that receives an inner rod 33 (shown in FIG. 13) molded into the inner side of the top wall 3 of the plastic body 2 so as to be pivotally connected to the inner rod 33. Therefore, the recess portion 23 of the pivot structure 22 is pivotally disposed relative to the top wall 3, forming a first pivot axis X and allows the legs 9a and 9b (shown in FIG. 12) to be pivoted together into the storage compartment 7. The top ends 19a, 19b of legs 9a, 9b, respectively, are within a leg retaining compartment 29a.

Referring back to FIG. 11, the leg retaining compartment 29a is formed by side wall 6b, top wall 3, inner ramps 30a and 30b, and side wall ramps 31a and 31b. The leg retaining compartment 29a is on the first side 26 of the plastic body 2. Another leg retaining compartment 29b (obstructed from view in FIGS. 1 and 2 by side wall 5b) is on the second side 27 (shown in FIG. 1) of the plastic body 2. Leg retaining compartment 29a and 29b are of essentially identical construction. Because leg retaining compartments 29a and 29b are essentially identical, only leg retaining compartment 29a will be discussed in detail, but the discussion applies equally to leg retaining compartment 29b. Inner ramps 30a and 30b are integrally molded with the inner surface of side walls 5a and 5b of the plastic body 2. Each inner ramp 30a and 30b is essentially identical, but molded on opposite side walls 5a and 5b, respectively. Each inner ramp 30a, 30b has a triangle-like configuration, with one side 67a, 67b, respectively, forming part of the leg retaining compartment 29a, one side 68a, 68b, respectively, formed by side wall 5a, 5b, respectively, and the hypotenuse 69a, 69b, respectively, molded to connect the sides 67a, 67b, respectively, and sides 68a, 68b, respectively. The triangle-like configuration is not intended to be limiting, and inner ramps 30a, 30b may have any other suitable configuration. Inner ramps 30a and 30b are spaced apart a distance approximately equal to the width of leg pair 9a, 9b when leg pair 9a, 9b is in a collapsed position. Therefore, inner ramps 30a, 30b form an opening 32 that permits leg pair 9a and 9b to be folded so as to be substantially disposed in the storage compartment 7. The inner ramps 30a and 30b also function to guide leg pair 9a, 9b toward one side of storage compartment 7 when leg pair 9a, 9b is collapsed into a storage position. For example, as can be seen from FIG. 7, the legs 9a, 9b pivotally connected toward the first side 26 of the top body 2 (near side wall 6b) is received toward the bottom side of the compartment 7, while the legs 9c, 9d are received toward the upper side of the compartment 7. It can be seen that the leg pairs 9a, 9b and 9c, 9d are disposed at an angle with respect to the longitudinal axis of top body 2. Furthermore, the side wall ramps 31a, 31b are molded on the inner side of the side walls 5a, 5b, respectively, of plastic body 2. The surface of the side wall ramps 31a, 31b is slanted outwardly from the top wall 3.

FIG. 12 shows an embodiment wherein the leg pair 9a, 9b is further pivoted relative to the first pivot axis X from the storage compartment 7 to a partially extended position.

FIG. 13 shows an embodiment wherein the leg pair 9a, 9b is pivoted relative to the first pivot axis X from the storage compartment 7 to an extended position. The top end 19a (obstructed from view by legs 9a, 9b), 19b (obstructed from view by legs 9a, 9b) of legs 9a, 9b is connected within the leg retaining compartment 29a.

In another aspect of the embodiment shown in FIG. 13, legs 9a and 9b are at least partially nested within one another. When legs 9a and 9b are nested within one another, the side rail 16b is at least partially within channel 18b. Side rail 16a is outside channel 18b. Side rail 16b′ is at least partially within channel 18a. Side rail 16a′ is outside channel 18a. Side rail 16a overlaps with side rail 16b′. Side rail 16b overlaps with side rail 16a′. This partially nested position enables legs 9a, 9b to be compactly arranged when folded into the storage compartment 7.

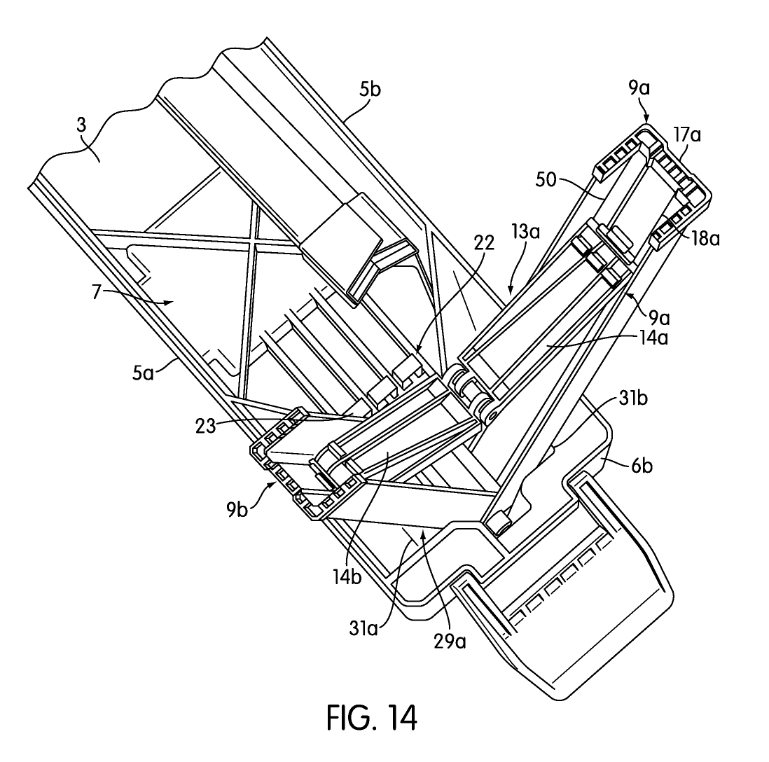

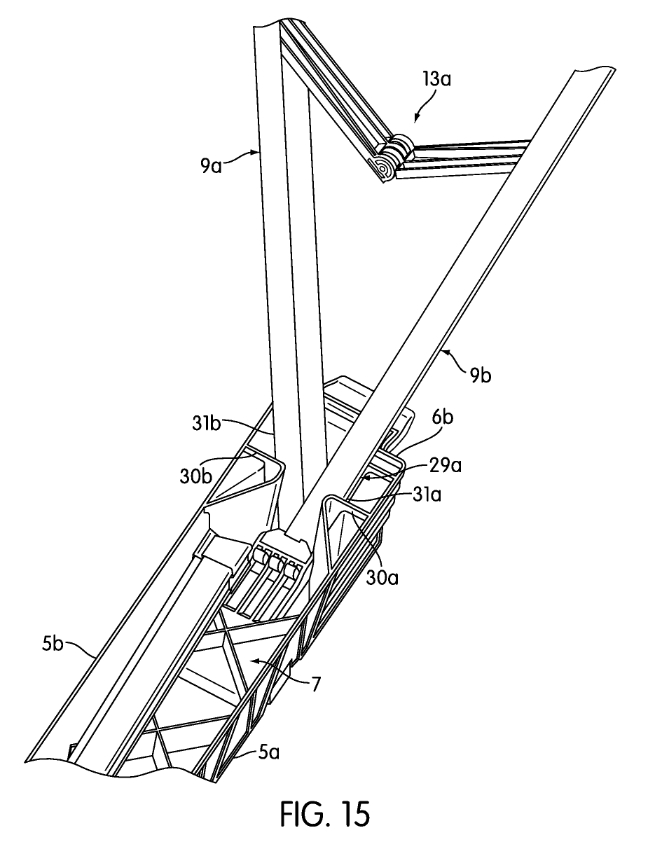

In the embodiment shown in FIGS. 14 and 15, the leg pair 9a, 9b is in an extended position and partially separated away from one another. The plastic material forming inner ramps 30a (shown in FIG. 15), 30b (shown in FIG. 15) and side wall 6b (or inner wall structure spaced from side wall 6b) forcibly or frictionally engage leg pair 9a, 9b, inhibiting the leg pair 9a, 9b from pivoting relative to pivot axis X (shown in FIGS. 8 and 9). In one embodiment, the leg retaining compartment 29a has a width dimension (when the legs are stored and the plastic material of the inner ramps 30a, 30b are not stressed) that is slightly less than the corresponding width dimension of the legs 9a, 9b. This forcible engagement of the plastic material with the legs facilitates retention of the legs in the deployed position with little or no wiggle or relative movement between the legs 9a, 9b and the plastic body 2.

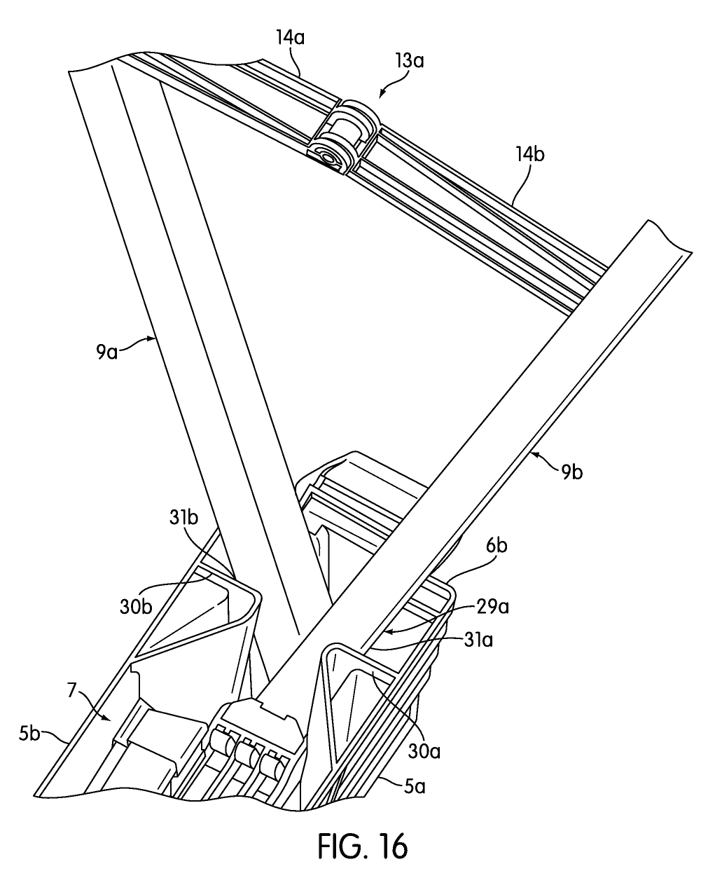

In the embodiment shown in FIG. 16, the leg pair 9a and 9b is in an extended position and the legs 9a and 9b are pivotally separated away from one another to the deployed position. The plastic surfaces of inner ramps 30a and 30b and side wall 6b forcibly engage leg pair 9a, 9b, inhibiting or selectively preventing the leg pair 9a, 9b from pivoting relative to pivot axis X (shown in FIGS. 8 and 9) until manually pivoted. The side wall ramps 31a and 31b (obstructed from view by leg 9a) also forcibly engage leg pair 9a, 9b, respectively, preventing the leg pair 9a, 9b from pivoting relative to the pivot axis Y (shown in FIGS. 8 and 9) until manually pivoted when desired. It should be appreciated that while this embodiment shows and describes forcible engagement of the legs with plastic surfaces formed on various ramp and on side surfaces, the body can be molded such that any shaped plastic structure can be formed to engage the metals legs and forcibly retain them in the deployed configuration. The forcible engagement of the metal legs slightly displaces the softer and more flexible material of the plastic, and the resilience of the displaced plastic (of whatever shape that may be engineered) applies a force against the metal legs to retain them in place.

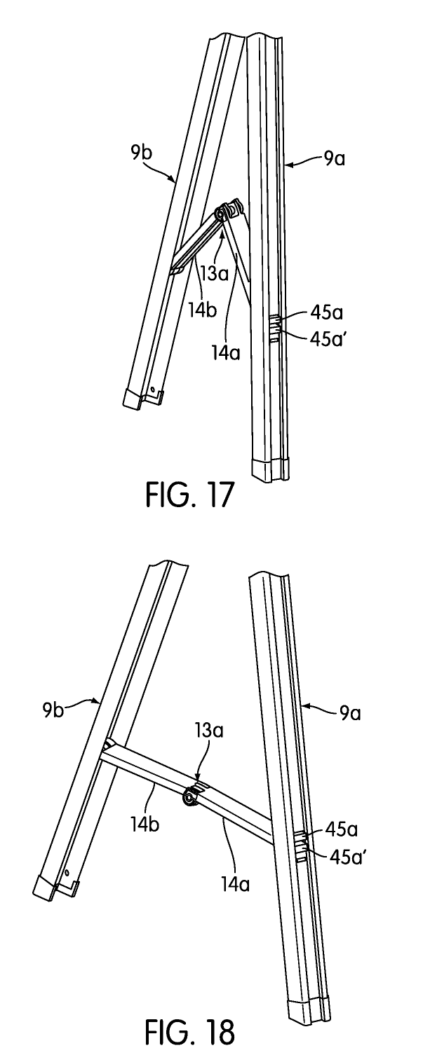

In the embodiment shown in FIG. 17, leg pair 9a and 9b is partially separated away from one another. Support rail 13a is folded such that portions 14 and 14b are partially folded together. Portions 14a and 14b are made from a resilient flexible plastic material.

In the embodiment shown in FIG. 18, legs 9a and 9b are pivotally separated away from one another in a deployed position. Support rail 13a is in a straight position such that portions 14a and 14b are aligned horizontally next to each other.

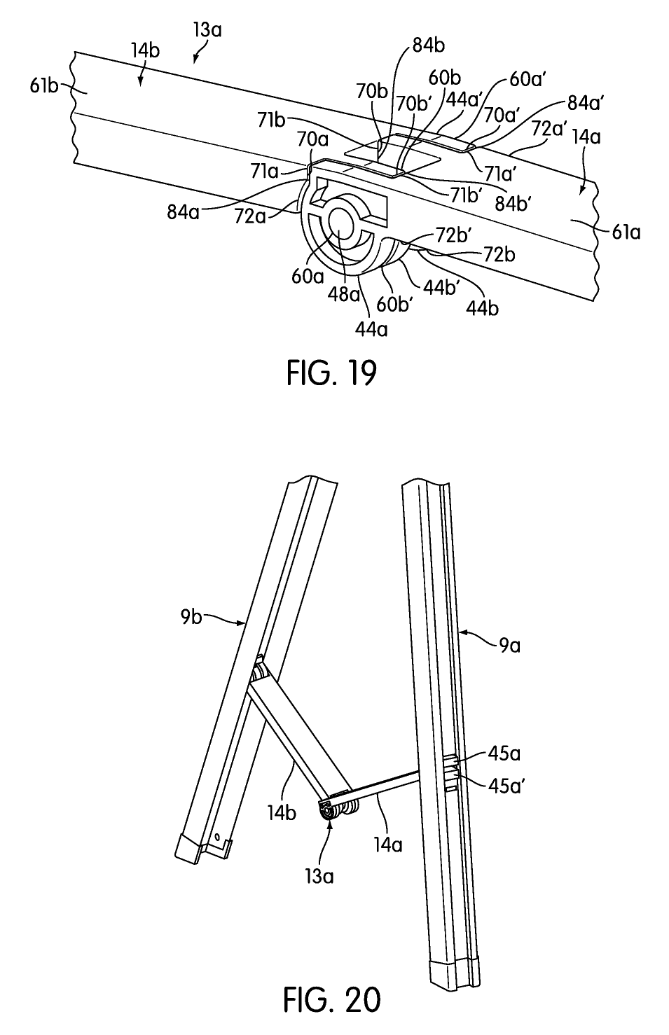

In the embodiment shown in FIG. 19, each portion 14a and 14b of the support rail 13a has ring portions, 44a and 44b (obstructed from view by ring portions 44a and 44b′) for portion 14a, and 44a′ (obstructed from view by ring portions 44a, 44b′, and 44b) and 44b′ (partially obstructed from view by ring portion 44a) for portion 14b, integrally molded on one end. Each ring portion 44a, 44b, 44a′, 44b′ is essentially identical and semi-circular in shape. Therefore, portion 14a has ring portions 44a, 44b integrally molded on one end. Portion 14b has ring portions 44a′, 44b′ integrally molded on one end. Each ring portion 44a, 44b, 44a′, and 44b′ has a center hole 60a, 60b (obstructed from view by ring portions 44a and 44b′), 60a′ (obstructed from view by ring portions 44a, 44b′, and 44b), and 60b′ (obstructed from view by ring portion 44a), respectively, located at a substantially centered position. Ring portions 44a, 44b and 44a′, 44b′ are molded below the top surfaces 61a and 61b, respectively, of portions 14a and 14b, respectively.

As shown in FIG. 19, portions 14a and 14b are pivotally disposed relative to each other. In FIG. 19, portion 14a is aligned with portion 14b such that center hole 60a in portion 14a is aligned with center hole 60b′ in portion 14b, and center hole 60b is aligned with center hole 60a′. A fastener pin 48a is inserted through center holes 60a and 60b′. A fastener pin 48b (shown in FIG. 13) is also inserted through center holes 60b and 60a′. Therefore, portions 14a and 14b are fastened together, and pivotally disposed relative to one another.

In another aspect of the embodiment shown in FIG. 19, ring receiving surfaces 72a, 72b (obstructed from view by ring portions 44a, 44b′), 72a′ (obstructed from view by ring portions 44a, 44b′, and 44b) and 72b′(obstructed from view by ring portion 44a) are located at a position adjacent to ring portions 44a, 44b, 44a′, and 44b′, respectively. Ring receiving surfaces 72a, 72b, 72a′, and 72b′ are essentially identical and have a curved shape configured to receive a portion of ring portions 44a, 44b, 44a′ and 44b′, respectively.

First stop surfaces 70a and 70b (partially obstructed from view by ring portions 44a, 44b′) are flat and are located above ring portions 44a and 44b, respectively, and below top surface 61a. First stop surfaces 70a′ (obstructed from view by ring portion 44a, 44b′, and 44b) and 70b′ (obstructed from view by ring portions 44a) are located above ring portions 44a′ and 44b′, respectively, and below top surface 61b. Second stop surfaces 71a, 71b (obstructed from view by ring portion 44a and 44b′) are located above ring receiving surfaces 72a, 72b, respectively, and below top surface 61b. Second stop surfaces 71a′ (obstructed from view by ring portions 44a, 44b′, and 44b), 71b′ (obstructed from view by ring portion 44a) are flat and are located above ring receiving surfaces 72a′, 72b′, respectively, and below top surface 61a. Second stop surfaces 71a, 71b, 71a′ and 71b′ are essentially identical. Second stop surfaces 71a, 71b, 71a′ and 71b′ intersect with ring receiving surfaces 72a, 72b, 72a′ and 72b′, respectively, at vertexes 84a, 84b (obstructed from view by ring portions 44a, 44b′), 84a′ (obstructed from view by ring portions 44a, 44b′, and 44b) and 84b′ (obstructed from view by ring portion 44a), respectively. Second stop surfaces 71a, 71b, 71a′ and 71b′ contact first stop surfaces 70a, 70b, 70a′ and 70b′, respectively, when support rail 13a is in a straight position. The contact between the first stop surfaces 70a, 70b, 70a′ and 70b′ and second stop surfaces 71a, 71b, 71a′ and 71b′ prevents or inhibits the ring portions 44a, 44b, 44a′ and 44b′ from pivoting or moving away from the plastic body 2 (as shown in FIG. 20; plastic body 2 shown in FIG. 1) unless the force applied to the support rail 13a exceeds a threshold level. Because portions 14a and 14b are made from a resilient flexible plastic material, if the force applied to support rail 13a exceeds the threshold level, first stop surfaces 70a, 70b, 70a′ and 70b′ are displaced from being in contact with second stop surfaces 71a, 71b, 71a′ and 71b′, respectively, and pass over vertexes 84a, 84b, 84a′ and 84b′, respectively, into a position below the second stop surfaces 71a, 71b, 71a′ and 71b′, respectively. The threshold level required to pivot or move ring portions 44a, 44b of portion 14a and ring portions 44a′, 44b′ of portion 14b away from the plastic body 2 (as shown in FIG. 20; plastic body 2 shown in FIG. 1) is greater than the force required to pivot portions 44a, 44b, 44a′, and 44b′ toward the plastic body 2 (as shown in FIG. 17; plastic body 2 shown in FIG. 1). Therefore, when portions 14a and 14b are pivotally disposed relative to each other, the force required to pivot or move the ring portions 44a, 44b, 44a′ and 44b′ away from the plastic body is greater than the force required to pivot or move ring portions 44a, 44b, 44a′ and 44b′ toward the plastic body 2.

In embodiment shown in FIG. 20, the support rail 13a is folded such that ring portions 44a, 44b of portion 14a and ring portions 44a′, 44b′ of portion 14b are pivoted or moved away from the plastic body 2. In order for portions 14a and 14b to be pivoted toward the plastic body 2, the force applied to the support rail 13a must exceed a threshold level. The threshold level required to pivot or move ring portions 44a, 44b of portion 14a and ring portions 44a′, 44b′ of portion 14b away from the plastic body 2 is greater than the force required to pivot or move ring portions 44a, 44b, 44a′, and 44b′ toward the plastic body 2 (shown in FIG. 17). This can occur when a user (inadvertently) steps on the support rail 13a.

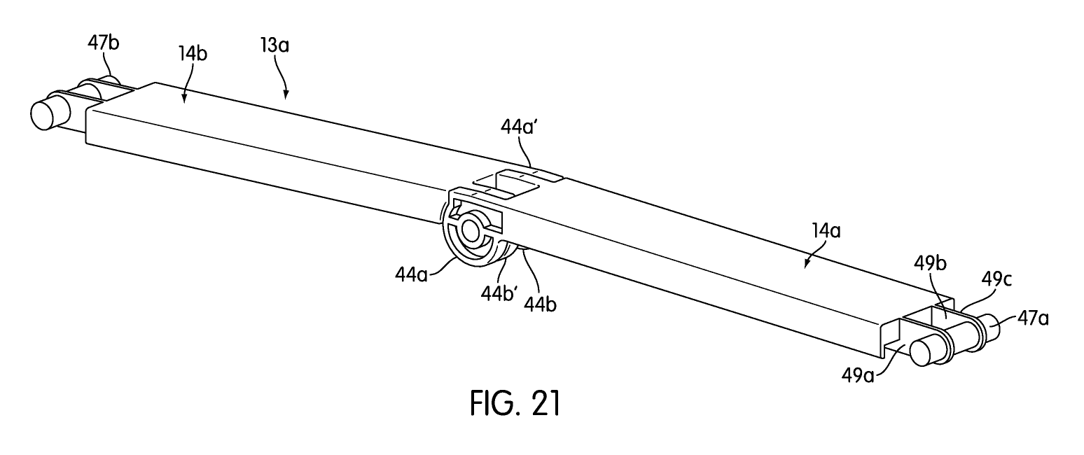

In the embodiment shown in FIG. 21, each portion 14a and 14b of the support rail 13a has a rod portion 47a and 47b, respectively, integrally molded on the end opposite from ring portions 44a, 44b and 44a′, 44b′, respectively. Ring portions 44a, 44b (partially obstructed from view by portions 44a and 44b′) and rod portion 47a are integrally molded with portion 14a so as to form a one-piece unitary molded structure. Similarly, ring portions 44a′ (obstructed from view by portions 44a, 44b′, and 44b), 44b′ (partially obstructed from view by portion 44a) and rod portion 47b are integrally molded with portion 14b so as to form a one-piece unitary molded structure. Because portions 14a, 14b are essentially identical, only portion 14a will be discussed in detail in this paragraph, but the discussion applies equally to portion 14b. Recesses 49a, 49b, and 49c are located between the rod portion 47a and the rest of portion 14a.

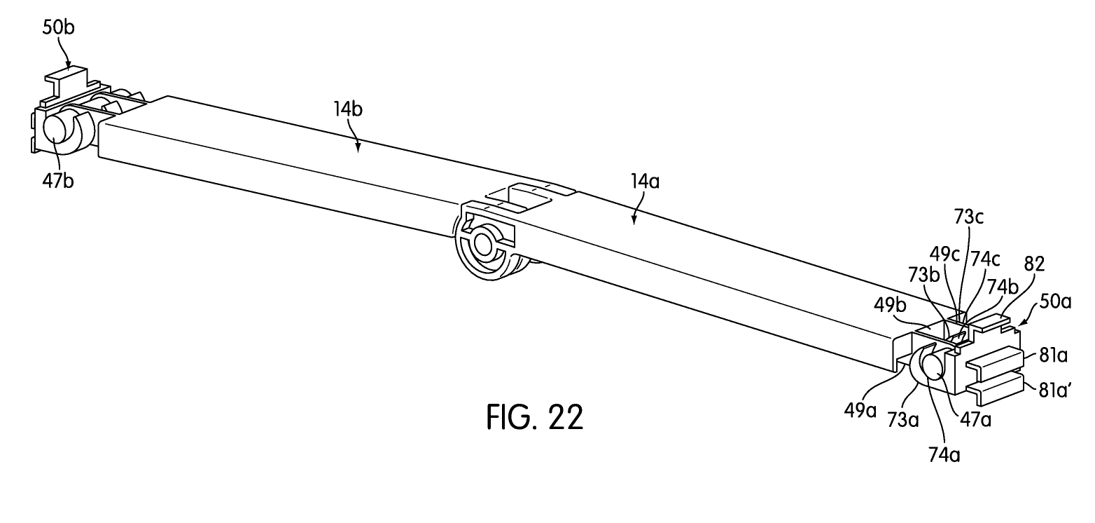

In the embodiment shown in FIG. 22, portion 14a is pivotally disposed relative to a rod receiving member 50a. Portion 14b is pivotally disposed relative to rod receiving member 50b. Rod receiving members 50a and 50b are mounted through the openings 45a (shown in FIG. 1), 45a′ (shown in FIG. 1) on leg 9a (shown in FIG. 1) and 45b (shown in FIG. 10), 45b′ (shown in FIG. 10) on leg 9b (shown in FIG. 10), respectively, and affixed inside channels 18a (shown in FIG. 13) and 18b (shown in FIG. 13), respectively. Because rod receiving members 50a and 50b are essentially identical, only rod receiving member 50a will be discussed in detail, but the discussion applies essentially to the rod receiving member 50b. The rod receiving member 50a has curved portions 73a, 73b (partially obstructed from view by rod portion 47a and rod receiving member 50a), and 73c (obstructed from view by rod portion 47a and rod receiving member 50a) integrally molded with the rod receiving member 50a. Curved portions 73a, 73b, and 73c are essentially identical, each having a curved shape forming recesses 74a, 74b, and 74c configured to receive rod portion 47a. Rod receiving member 50a receives the rod portion 47a into recesses 74a, 74b, and 74c such that curved portions 73a, 73b, and 73c are aligned with recesses 49a, 49b, and 49c, respectively, allowing portion 14a to be pivotally disposed relative to rod receiving member 50a. Tabs 81a and 81a′ are latched through openings 45a and 45a′ to affix rod receiving member 50a inside channel 18a (shown in FIG. 14). The stop tab 82 forcibly engages the inner surface of the center rail 17a (shown in FIG. 14) to help affix rod receiving member 50a inside channel 18a.

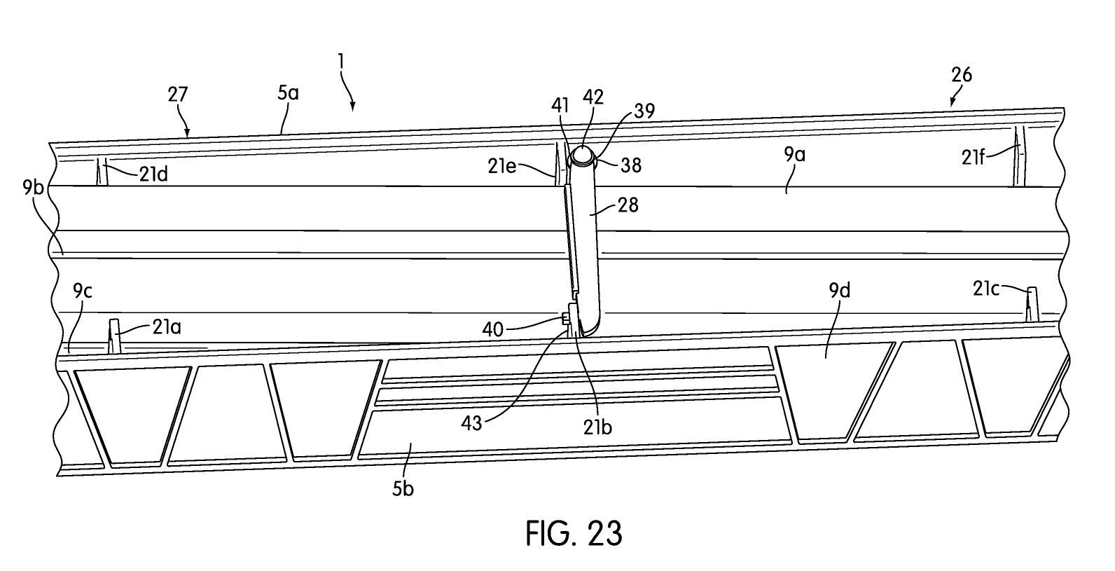

In the embodiment shown in FIG. 23, leg pair 9a, 9b and leg pair 9c, 9d are frictionally held in place in the storage compartment by ribs 21a, 21b, 21c, 21d, 21e, and 21f integrally molded the side walls 5a and 5b. Side wall 5b has integral plastic ribs 21a, 21b, 21c molded at equally spaced positions along the inner surface. Side wall 5a also has ribs 21d, 21e, 21f molded at equally spaced positions along the inner surface. When the legs 9a, 9b, 9c, and 9d are in a storage position, leg pair 9a, 9b and leg pair 9c, 9d forcibly engage with the ribs 21a, 21b, 21c, 21d, 21e, and 21f, displacing the plastic material slightly so that legs 9a, 9b, 9c, and 9d remain in a storage position. Each rib 21a, 21b, 21c, 21d, and 21e is essentially identical.

As shown in FIG. 23, which is a perspective view of the underside of the body 2, a latch member 28 is pivotally connected to side wall 5a by a fastener 42 and latchable to the opposite side wall 5b to further prevent the legs from pivoting from a storage position into an extended position. The latch member 28 is approximately the same length as distance between the inner surfaces of side walls 5a and 5b. The latch member 28 comprises an aperture 39 at one end and an abutment 40 at the other end. The abutment 40 is integrally molded with the latch member 28 so as to form a one-piece unitary molded structure. The abutment 40 is perpendicular to the length of the latch member 28. An ring 38 with an opening 41 is molded with the side wall 5a adjacent to rib 21e for receiving a fastener 42. The fastener 42 is then inserted through the aperture 39 and inside the opening 41, pivotally fastening the latch member 28 to the side wall 5a. To latch the latch member 28 to side wall 5b, the abutment 40 is inserted into a hole 43 (partially obstructed from view) formed in rib 21b.

In the embodiment shown in FIG. 23, the latch member 28 is made of plastic. The use of plastic is not intended to be limiting, and the latch member 28 may be made of metal or any other suitable material or combination thereof as is well known in the art.

In another aspect of embodiment shown in FIG. 23, the folding sawhorse 1 is in a storage position. Legs 9a are 9b are partially nested within one another. Legs 9c and 9d are also partially nested within one another. The leg pair 9a, 9b connected to first side 26 are disposed parallel to the leg pair 9c, 9d connected to the second side 27 of the folding sawhorse 1. Leg pair 9a, 9b is pivoted relative to pivot axis Y (shown in FIGS. 8 and 9) toward side wall 5a. Similarly, leg pair 9c, 9d is pivoted relative to pivot axis Y (shown in FIGS. 8 and 9) toward side wall 5b. The pivoting of leg pair 9a, 9b toward side wall 5a and leg pair 9c, 9d toward side wall 5b allows for angled storage position for legs 9a, 9b, 9c, and 9d. The hypotenuse 69a (shown in FIG. 11) of inner ramp 30a (shown in FIG. 11) operates to guide the legs 9a, 9b to have an angled orientation relative to a central longitudinal axis of the body 2 when in the storage position to enable leg pair 9a, 9b connected to first side 26 of the folding sawhorse 1 to be positioned in a side-by-side relationship to leg pair 9c, 9d connected to second side 27 of the folding sawhorse 1 when in the storage position. Similarly, another hypotenuse (not shown) of another inner ramp (not shown) on second side 27 operates to guide the legs 9c, 9d to have an angled orientation relative to a central longitudinal axis of the body 2 when in the storage position to enable leg pair 9c, 9d connected to second side 27 of the folding sawhorse 1 to be positioned in a side-by-side relationship to leg pair 9a, 9b connected to first side 26 of the folding sawhorse 1 when in the storage position. The angled orientation of legs 9a, 9b, 9c, and 9d enable both leg pair 9a, 9b and leg pair 9c, 9d to be compactly stored inside the storage compartment 7.

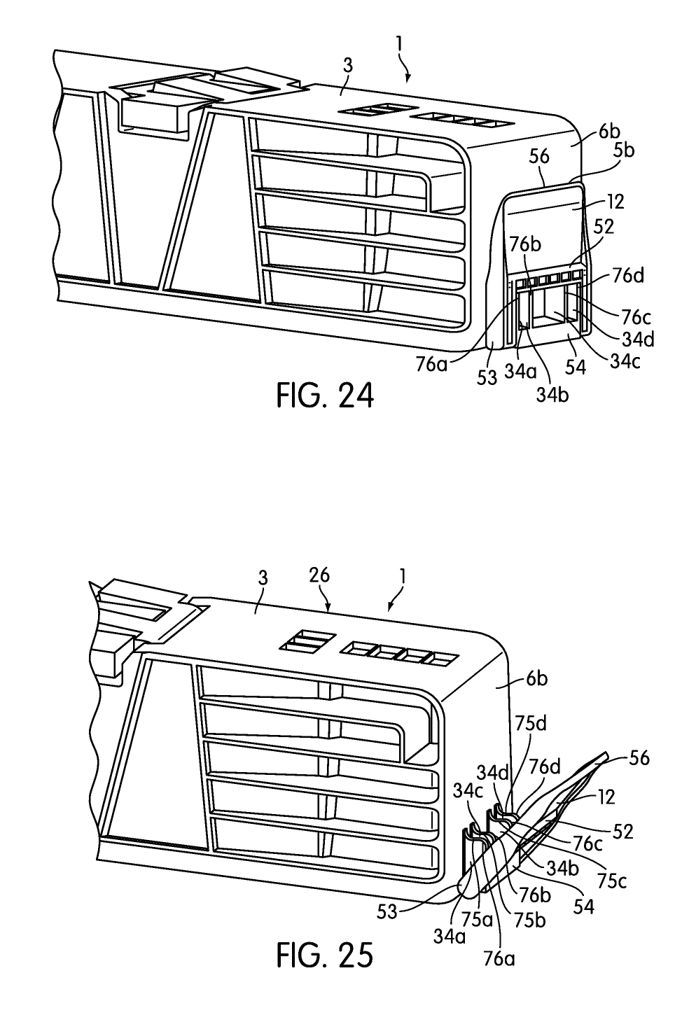

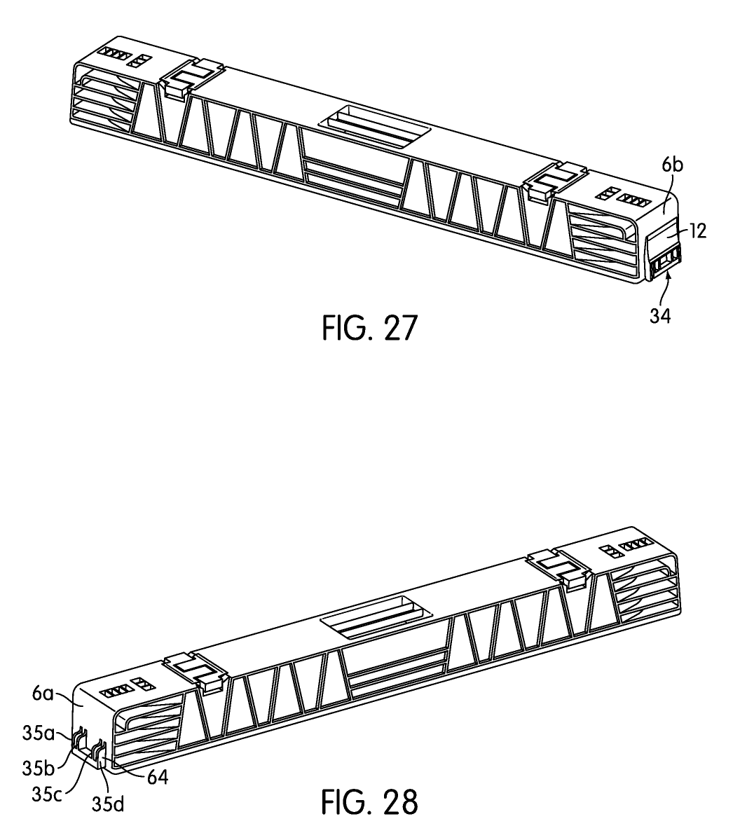

In the embodiment shown in FIGS. 24, 25, and 26, the leg pair 9a and 9b and leg pair 9c and 9d are in a storage position. A connecting latch 12 is connected relative to side wall 6b. The connecting latch 12 comprises a latching portion 52, pivoting rod 53 (obstructed from view by latch retaining protrusion 54), and a handle 56. The connecting latch 12 enables the folding sawhorse 1 to be latched to another folding sawhorse 1′ (shown in FIGS. 27, 28, and 29). A latch retaining protrusion 54 is molded with side wall 6b. The latch retaining protrusion 54 further comprises a recess or optionally a protrusion configured to pivotally connect with pivoting rod 53 so that connecting latch 12 is pivotally disposed relative to side wall 6b.

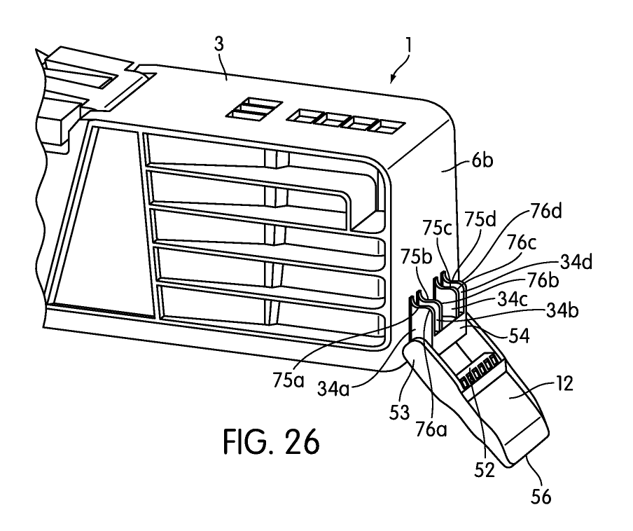

In another aspect of the embodiment shown in FIGS. 24, 25, and 26, latch retaining abutments 34a, 34b, 34c, and 34d (collectively 34) are molded into the outer surface of the side wall 6b. Latch retaining abutments 34a, 34b, 34c, and 34d are essentially identical. Each latch retaining abutment has lower surfaces 75a, 75b, 75c and 75d (collectively 75) (shown in FIGS. 25 and 26), respectively, and upper surfaces 76a, 76b, 76c and 76d (collectively 76), respectively. The lower surfaces 75 are curved surfaces configured for receiving latching portion 52. The upper surfaces 76 are curved surfaces on latch retaining abutments 34 that are a larger distance away from side wall 6b than the distance between lower surfaces 75 and side wall 6b. Lower surfaces 75 are concave (curved inwardly), while upper surfaces 76 are convex (curved outwardly). The latching portion 52 must first contact upper surfaces 76 when latching portion 52 is forcibly engaged with the latch retaining abutments 34.

In another aspect of the embodiment shown in FIGS. 24, 25, and 26, the width dimension between latching portion 52 and pivoting rod 53 is slightly less than the width dimension between pivoting rod 53 and upper surfaces 76. To hold the connecting latch 12 against side wall 6b, latching portion 52 is forcibly engaged with the upper surfaces 76 of leg retaining abutments 34. Because the connecting latch 12 and leg retaining abutments 34 are both made of resilient flexible plastic material, the forcible engagement between the connecting latch 12 and the leg retaining abutments 34 displaces the latching portion 52 and upper surfaces 76, allowing the latching portion 53 to contact lower surfaces 75. The contact between latching portion 52 and lower surfaces 75 frictionally holds connecting latch 12 along side wall 6b (as shown in FIG. 19). Each latch retaining abutment 34a, 34b, 34c, and 34d provides an incremental amount of frictional force for holding connecting latch 12 against side wall 6b. Essentially, the configuration described is a “snap fit” configuration where the latching portion 52 “snap fits” with leg retaining abutments 34. This configuration prevents the connecting latch 12 from swinging freely (shown in FIGS. 20 and 21) when connecting latch 12 is not in use.

In the embodiment shown in FIG. 27, the connecting latch 12 is held along side wall 6b by leg retaining abutments 34.

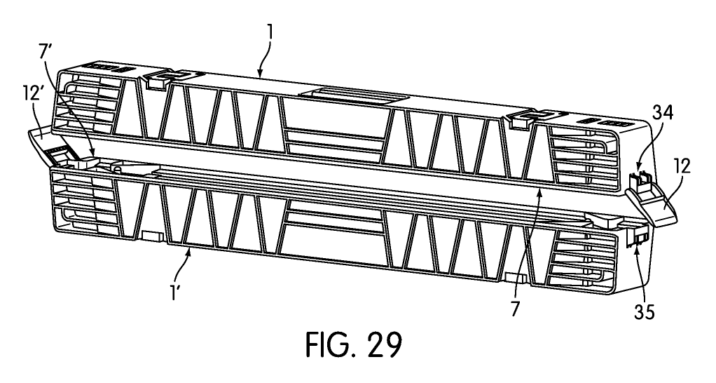

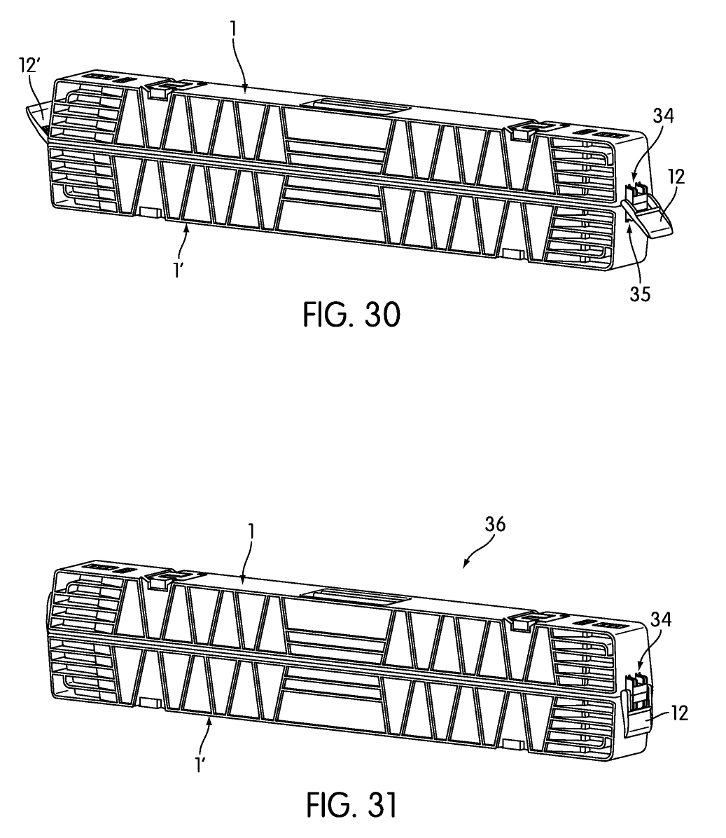

In the embodiment shown in FIG. 28, side wall 6a has latch receiving protrusion 64 having latch receiving abutments 35a, 35b, 35c, and 35d (collectively referred to as 35) molded into the outer surface of side wall 6a. Latch receiving protrusion 64 and latch receiving abutments 35 are essentially identical to latch retaining protrusion 54 (shown in FIGS. 22, 23 and 24) and latch retaining abutments 34 (shown in FIGS. 22, 23 and 24), respectively. The only difference between latch receiving protrusion 64 and latch retaining protrusion 54 is that latch retaining protrusion 54 carries connecting latch 12. Because latch receiving abutments 35 are essentially identical to latch retaining abutments, latch receiving abutments 35 essentially operate identically to latch retaining abutments 34 to receive a connecting latch 12′ (shown in FIGS. 29 and 30) of another folding sawhorse 1′ (shown in FIGS. 29 and 30).

In the embodiment shown in FIGS. 29, 30, and 31, folding sawhorse 1 is placed on top of folding sawhorse 1′ such that the storage compartment 7 of folding sawhorse 1 faces the storage compartment 7′ of folding sawhorse 1′. Furthermore, the folding sawhorses 1 and 1′ are aligned such that connecting latch 12 on folding sawhorse 1 can be latched to latch receiving abutments 35 on folding sawhorse 1′. The connecting latch 12 of folding sawhorse 1 is then latched to the latch receiving abutments 35 of folding sawhorse 1′, and vice versa for folding sawhorse 1′. When latched together, the two folding sawhorses 1 and 1′ form a twin pack configuration 36 (as shown in FIG. 26). The twin pack configuration 36 enables both folding sawhorse 1 and 1′ to be more easily carried from one place to another.

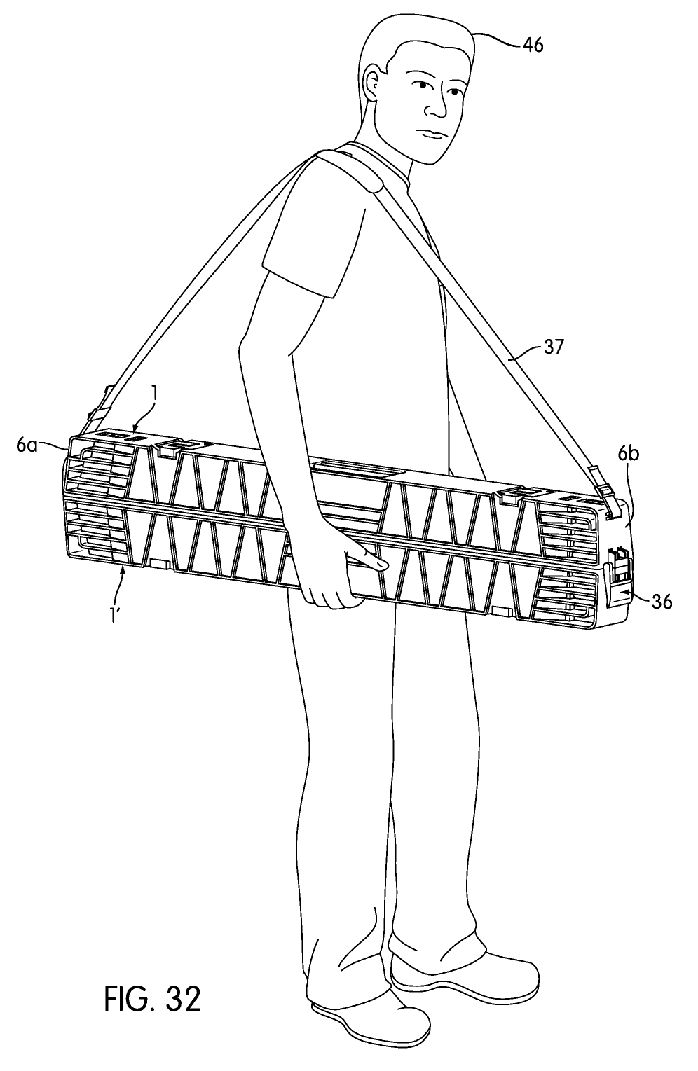

In the embodiment shown in FIG. 32, a carrying strap 37 is attached to side walls 6a and 6b of the twin pack configuration 36 of folding sawhorses 1 and 1′. The carrying strap 37 may be adjustable. A user 46 can then carry the twin pack configuration 36 from one place to another.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment may be combined with one or more features of any other embodiment.

What is claimed is:

1. A folding sawhorse, comprising:
an elongate plastic body having a top wall with an upper work surface, and a plurality of side walls, the walls defining a storage compartment;
a plurality of metal legs that are pivotally disposed relative to the plastic body, the legs being movable between a deployed position wherein the legs are capable of supporting the plastic body in a condition for use, and a storage position in which the legs are folded so as to be substantially disposed in the storage compartment, wherein the metal legs forcibly engage with adjacent plastic surfaces of the plastic body when the legs are in the deployed position.

2. The folding sawhorse according to claim 1, further comprising a support rail, connected between a pair of the legs, the support rail comprising two portions, wherein each portion is pivotally disposed relative to the other portion, and wherein each portion is pivotally disposed relative to one of the pair of legs.

3. The folding sawhorse according to claim 2, wherein each portion comprises ring portions at one end.

4. The folding sawhorse according to claim 3, wherein each portion further comprises first and second stop surfaces.

5. The folding sawhorse according to claim 4, wherein the first and second stop surfaces contact each other when the support rail is in a straight position.

6. The folding sawhorse according to claim 5, wherein the first and second stop surfaces stop the ring portions from pivoting away from the plastic body unless a force applied to the support rail exceeds a threshold level.

7. The folding sawhorse according to claim 6, wherein the threshold level is greater than the force required to pivot or move the ring portions toward the plastic body.

8. The folding sawhorse according to claim 1, further comprising a leg latch that prevents the legs from being moved from the storage position to the deployed position, wherein the leg latch is pivotally disposed relative to a side wall of the plastic body.

9. The folding sawhorse according to claim 1, further comprising a connecting latch that enables the sawhorse to be latched to another folding sawhorse.

10. The folding sawhorse according to claim 9, wherein the connecting latch further comprises a latching portion, a pivoting rod, and a handle.

11. The folding sawhorse according to claim 10, further comprising a latch retaining protrusion.

12. The folding sawhorse according to claim 11, wherein the latch retaining protrusion further comprises a recess or optionally a protrusion configured to pivotally connect with the pivoting rod

13. The folding sawhorse according to claim 12, wherein abutments are molded into the outer surface of one of the sidewalls.

14. The folding sawhorse according to claim 13, wherein each abutment has lower surfaces and upper surfaces.

15. The folding sawhorse according to claim 14, wherein the lower surfaces are curved surfaces configured for receiving the latch portion.

16. The folding sawhorse according to claim 15, wherein the latching portion must first contact upper surfaces when the latching portion is forcibly engaged with the abutments.

17. The folding sawhorse according to claim 1, wherein the plastic surfaces extend inwardly from the sidewalls towards the storage compartment.

18. The folding sawhorse according to claim 17, wherein the plastic surfaces comprise regions that forcibly engage the legs when in the storage position.

19. The folding sawhorse according to claim 18, wherein the plastic surfaces operate to guide the legs to have an angled orientation relative to a central longitudinal axis of the body when in the storage position to enable a pair of the legs connected to one side of the sawhorse to be positioned in side-by-side relationship to a pair of the legs connected to an opposite side of the sawhorse when in the storage position.

20. The folding sawhorse according to claim 19, wherein when in the storage position, the pair of legs connected to the one side of the sawhorse are disposed parallel to the pair of legs connected to the opposite side of the sawhorse.

21. The folding sawhorse according to claim 20, wherein when in the storage position, the pair of legs connected to one side of the sawhorse are at least partially nested within one another, and the pair of legs connected to the opposite side of the sawhorse are at least partially nested within one another.

22. The folding sawhorse according to claim 21, wherein the plastic body has ribs integrally molded with the inner surfaces of the side walls.

23. The folding sawhorse according to claim 22, wherein when in the storage position, both pairs of legs forcibly engage the ribs, displacing the plastic material slightly, so that pair of legs remain in the storage position.

24. A folding sawhorse, comprising:
an elongate body having a top wall with an upper work surface, and a plurality of side walls, the walls defining a storage compartment;
a plurality of legs, including a first leg pair pivotally mounted towards a first side of the body, and a second leg pair pivotally mounted towards a second side of the body;
the legs being movable between a deployed position wherein the legs are capable of supporting the plastic body in a condition for use, and a storage position in which the legs are folded so as to be substantially disposed in the storage compartment,
each leg pair comprising a first pivot axis allowing the pair of legs to be pivoted together outwardly from the storage compartment to an extended position, and a second pivot axis allowing the pair of legs to be pivotally separated away from one another to the deployed position.

25. The folding sawhorse according to claim 24, wherein the first pivot axis and the second pivot axis are provided by a pivot structure.

26. The folding sawhorse according to claim 25, wherein the pivot structure is formed from a single structure defining two axes.

27. The folding sawhorse according to claim 26, wherein the pivot structure comprises a rod portion and a recess portion.

28. The folding sawhorse according to claim 27, wherein the rod portion of the pivot structure is inserted through a through-hole formed in the pair of legs, providing the second pivot axis.

29. The folding sawhorse according to claim 28, wherein an inner rod is molded into the inner side of the top wall.

30. The folding sawhorse according to claim 29, wherein the recess portion of the pivot structure is pivotally attached to an inner rod, providing the first pivot axis.

31. The folding sawhorse according to claim 30, wherein the first and second pair of legs pivot relative to the second pivot axis inside the storage compartment, allowing for angled storage positions for first and second pair of legs.

32. A folding sawhorse comprising:
an elongate, one-piece integrally molded plastic body, the one-piece integrally molded plastic body being molded to include each of (a) a top wall defining a work surface, (b) side walls, (c) and a handle portion recessed in the top wall so as not to project above the work surface; and
a plurality of legs that are connected with the body and capable of supporting the body in a condition of use.

33. The folding sawhorse according to claim 32, wherein the handle portion is located at a position substantially centered between the side walls.

34. The folding sawhorse according to claim 33, wherein the top surface of the handle portion lies in the same plane as the surface as the top wall

35. The folding sawhorse according to claim 34, wherein the top wall serves as the major work surface.

36. The folding sawhorse according to claim 35, wherein the top surface of the handle portion can function as part of the work surface.

37. A folding sawhorse comprising:
an elongate body having a top wall with an upper work surface, and a plurality of side walls, the walls defining a storage compartment;
a plurality of legs that are pivotally disposed relative to the body, the legs being movable between a deployed position wherein the legs are capable of supporting the plastic body in a condition of use, and a storage position in which the legs are folded so as to be substantially disposed in the storage compartment; and
a latch member pivotally connected with one of the side walls and latchable to an opposite of the side walls to lock the legs in the storage compartment.

38. The folding sawhorse according to claim 37, wherein the latch member comprises an aperture at one end and an abutment integrally molded with the latch member at the other end.

39. The folding sawhorse according to claim 38, wherein the abutment is perpendicular to the length of the latch member.

40. The folding sawhorse according to claim 39, wherein the latch member is pivotally connected to one side wall by a fastener.

41. The folding sawhorse according to claim 40, wherein one side wall further comprises an integrally molded rib.

42. The folding sawhorse according to claim 41, wherein a hole is formed in the rib.

43. The folding sawhorse according to claim 42, wherein the hole is configured to receive the abutment.

44. The folding sawhorse according to claim 43, wherein the abutment of the latch member is inserted into the hole formed in the rib integrally molded into one side wall.
